(19) United States
(12) Patent Application Publication
(10) Pub. No.: US 2013/0317735 A1
(43) Pub. Date: Nov. 28, 2013

(54) METHOD AND APPARATUS FOR ASSOCIATING PANORAMIC IMAGES WITH ROUTING INFORMATION

(71) Applicant: Thomas Mann, Berlin (DE)

(72) Inventor: Thomas Mann, Berlin (DE)

(73) Assignee: Nokia Corporation, Espoo (FI)

(21) Appl. No.: 13/480,836

(22) Filed: May 25, 2012

(51) Int. Cl. G01C 21/00

(52) U.S. Cl. 701/400

(57) ABSTRACT

An approach for generating a panoramic image for depicting a selected travel route is described. A panoramic view generator processes and/or facilitates a processing of at least one route to cause, at least in part, a generation of at least one panoramic image representing the at least one route, wherein a first axis of the at least one panoramic image represents a time or a distance on the at least one route, and wherein a second axis represents one or more contextual parameters associated with the at least one route.

### BACKGROUND

Service providers and device manufacturers (e.g., wireless, cellular, etc.) are continually challenged to deliver value and convenience to consumers by, for example, providing compelling network services. One area of interest is providing device users with on demand access to routing information, including maps, routes and points-of-interest data. Typically, route options are shown either as lines on a map, as a list of navigation directions or as a graphical representation of different transport modes. Such visualizations focus primarily on the length of travel and duration of time to be experienced by the user as a result of the suggested route. Unfortunately, there is currently no convenient solution for enabling device users to select or compare route options based on a visual impression of the journey to be experienced.

### SOME EXAMPLE EMBODIMENTS

Therefore, there is a need for an approach for generating a panoramic image for depicting a selected travel route.

According to one embodiment, a method comprises processing and/or facilitating a processing of at least one route to cause, at least in part, a generation of at least one panoramic image representing the at least one route, wherein a first axis of the at least one panoramic image represents a time or a distance on the at least one route, and wherein a second axis represents one or more contextual parameters associated with the at least one route.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of at least one route to cause, at least in part, a generation of at least one panoramic image representing the at least one route, wherein a first axis of the at least one panoramic image represents a time or a distance on the at least one route, and wherein a second axis represents one or more contextual parameters associated with the at least one route.

According to another embodiment, a computer-readable storage medium carries one or more sequences of one or more instructions which, when executed by one or more processors, cause, at least in part, an apparatus to process and/or facilitate a processing of at least one route to cause, at least in part, a generation of at least one panoramic image representing the at least one route, wherein a first axis of the at least one panoramic image represents a time or a distance on the at least one route, and wherein a second axis represents one or more contextual parameters associated with the at least one route.

According to another embodiment, an apparatus comprises means for processing and/or facilitating a processing of at least one route to cause, at least in part, a generation of at least one panoramic image representing the at least one route, wherein a first axis of the at least one panoramic image represents a time or a distance on the at least one route, and wherein a second axis represents one or more contextual parameters associated with the at least one route.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating a panoramic image for depicting a selected travel route, according to one embodiment;

FIG. 2A is a diagram of the components of a panorama image generator, according to one embodiment;

FIGS. 2B-2F are depictions of images used or generated by the panoramic image generator for representing a selected travel route, according to various embodiments.

FIGS. 3A-3D are flowcharts of a process for generating a panoramic image for depicting a selected travel route, according to various embodiments;

FIGS. 4A and 4B are diagrams of user interfaces utilized in the processes of FIGS. 3A-3D, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for generating a panoramic image for depicting a selected travel route. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to routes generated via a mapping application, it is contemplated that the approach described herein may be used with any service for supporting user travel and interaction within a given environment. This may include, for example, an event planning application, a deal finder/shopping application, a sightseeing application, a travel ticket purchasing service (e.g., purchase of train or bus tickets), a travel logging service, or the like.

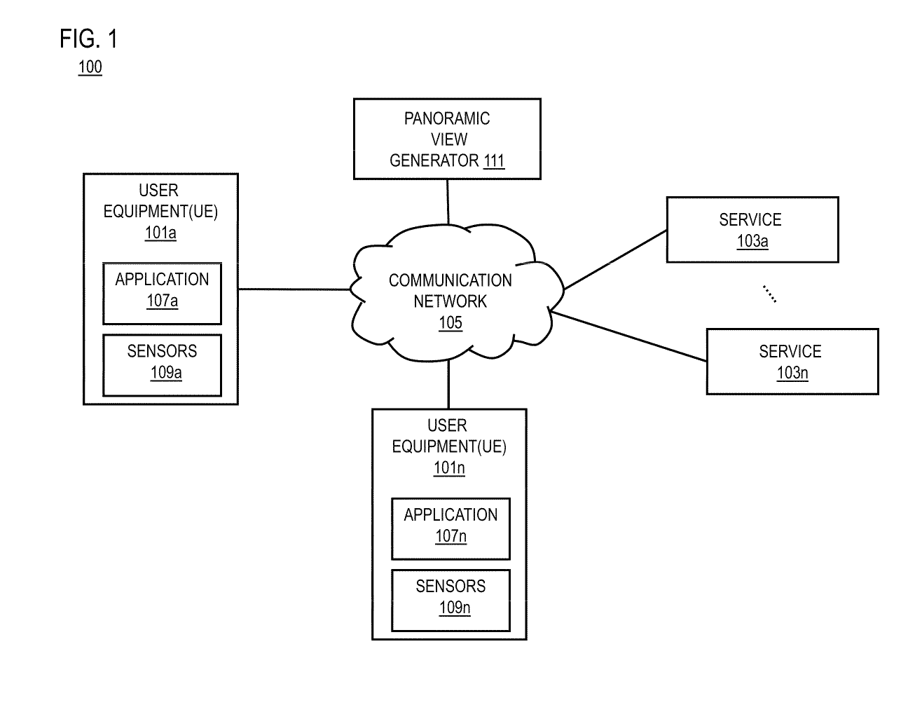

FIG. 1 is a diagram of a system capable of generating a panoramic image for depicting a selected travel route, according to one embodiment. As noted previously, device users regularly rely on routing applications and corresponding services to access information regarding a route they plan to travel or are currently traveling along. By way of such tools, users may access maps for detailing a travel route, navigation directions, information regarding various points-of-interest (e.g., landmarks, shopping centers) they may encounter along the route, etc. Typically, route options are shown either as lines on a map or as a text based list of navigation directions. In some instances, the route is depicted in accordance with a selected mode of transport, i.e., travel by car, bus, train or pedestrian travel.

Unfortunately, all of the above described approaches are rendered to a display of the user device—via the application or service—based on the length of travel and/or duration of time to be experienced by the user per the suggested route. Unfortunately, there is currently no convenient solution for enabling device users to select or compare route options based on a visual impression of the journey to be experienced. Resultantly, this limits the ability of users to select a preferred scenic experience as well as make travel planning decisions based on their expected visual perspective, i.e., a particular side of a train to sit on.

To address this problem, a system 100 of FIG. 1 introduces the capability to generate panoramic views of various routes selected by a user. By way of example, the system 100 includes a panoramic view generator 111, which interacts with the various services 103a-103n and/or applications 107a-107n of the user device, i.e., user equipment (UE) 101a-101n. For the purpose of illustration, the applications 107a-107n, referred to herein collectively as applications 107, may include a routing application, mapping application, travel planning application or the like. Likewise, the services 103a-103n, referred to herein collectively as services 103, may include a routing service, mapping service, travel planning service or the like for interacting with the various applications 107.

In certain embodiments, the panoramic view generator 111 enables the panoramic view, for representing a selected travel route, journey or event sequence, to be rendered to a display of the UE 101 concurrent with other information regarding the route. This may include, for example, enabling the display of a map for depicting various waypoints the user is to navigate from a point of origin to a destination along with a panoramic view depicting said route from the point of origin to the destination. The panoramic view may include, for example, a compilation of blended and merged images for depicting various scenic elements within view of the user as they travel along the route, including vehicles, landmarks, people, animals, buildings, landscapes, cityscapes and various points-of-interest corresponding to the route. In addition, the panoramic view may be generated to depict a given contextual condition associated with the travel route, including a weather or road condition. By way of this approach, the panoramic view may be reviewed by the user for enabling them to perceive or predict the scenery associated with the travel route.

In another embodiment, the panoramic view generator 111 operates in connection with the services 103 or applications 107 to enable comparative route selection based on different generated panoramic views. By way of example, a first panoramic view may be generated by the generator 111 for depicting various scenic elements to be experienced by the user with respect to a first route. Also, a second panoramic view may be generated by the generator 111 for depicting various scenic elements to be experienced by the user with respect to a second route. Under this approach, the user may select between the different routes on the basis of the viewing experience they can expect rather than simply on the basis of the distance, time or mode of travel for reaching of a given destination. It is noted, therefore, that the comparative viewing may offer the user an opportunity to preview the various sights, points-of-interest, environmental objects and other scenic elements they may experience prior to actual navigation along the route.

The panoramic view can be generated as multiple tiled images for representing the route. By way of example, the horizontal axis represents the time and/or distance duration of the route while the vertical axis includes the various graphical representations of scenic elements at the corresponding point of the journey. In the context of a two dimensional panoramic view, the scenic elements and contextual conditions are presented to the user concurrent with the specific point the user has traversed the travel route. Hence, certain tiles for representing a daytime temporal condition may elapse after the user has surpassed a corresponding point and/or time along the route while those for representing a night condition remains. Alternatively, a marker may be shown to advance along the horizontal axis for representing the current point and/or time elapsed along the route. It is noted that the generator 111 may combine a number of tiles for generating the panoramic view commensurate with the amount of time and/or distance required for the user to traverse the route.

A contextual condition associated with a given panoramic view, including a weather condition, environmental condition, temporal condition (e.g., the time of day) or the like at a particular point (time and/or distance), may be generated based on various sensor data. For example, the one or more sensors 109a-109n collectively referred to herein as sensors 109, may actively collect context information in association with a routing request. This information is then passed on to the panoramic view generator 111 for enabling the calling application 107 and/or corresponding service 103 to generate one or more routes. Under this scenario, the sensors may include a weather sensor, a global positioning sensor, a position sensor, a speed sensor, etc. Resultantly, the data can be used to access local weather forecast data, traffic condition data, road condition data, landscape data and other data corresponding to the current location of the user as well as the future location of the user relative to the indicated final destination. Of note, the panoramic view may therefore encompass images for representing an expected scenery experience of the user based, at least in part, on present contextual conditions, the amount of time and/or distance required to reach a destination, current user activities, etc.

In certain embodiments, the panoramic view generator 111 may also be configured to persistently gather and monitor context data to permit adaptation of a panoramic view responsive to a change in user behavior or context. For example, in the case where a user is delayed due to a traffic jam or unexpected road condition, the panoramic view representing the route may be updated to reflect a new expected time of arrive at the destination. Under this scenario, the image may be updated to reflect a late evening arrival as opposed to an original late afternoon arrival. As another example, in the case where the user deviates from the originally selected travel route, an updated panoramic view may be generated for depicting the user perspective relative to the deviant route. Under this scenario, the image may be appended with an additional or alternative tile for representing an industrial landscape through which the user will now travel. Of note, the updating may be triggered for execution by the panoramic view generator 111 by the application 107 and/or service 103 in response to periodically queried sensor data; the sensor data serving as sample points for determining whether an updating of the panoramic view is required.

In certain embodiments, the panoramic view generator 111 generates the panoramic view based on a specific perspective of the user. For example, in the case of vehicular travel (e.g., train, bus, automobile), the perspective may pertain to a specific side of the vehicle from which the user wishes to view scenes along the travel route. As another example, in the case of pedestrian travel, the perspective may pertain to the specific side of the street the user wishes to view as they traverse a route. The perspective may be specified by the user, such as during entry of the route parameters (e.g., point of origin, destination, mode of travel, preferred route conditions) via the application 107 or service 103. As such, the perspective may be processed by the panoramic view generator 111 as a condition for generation of the panoramic view. Under this scenario, when a user is investigating train travel options via a travel planning application or service, the generator 111 may enable presentment of a left side and right side perspective of the travel route. The user can then select the perspective of the travel route that most suits their interests.

In certain embodiments, the panoramic view generator 111 enables the user to expand or compress a panoramic view generated in connection with a travel route based on a specified focal point. For example, a user may select a focal point corresponding to a specific scenic element, time or distance travelled. In response to the selection, the horizontal and/or vertical axis corresponding to the focal point may be expanded, such that the panoramic view is representative of this expansion. As another example, the panoramic view may be expanded or compressed in proportion to a selected degree of granularity of a map view of the selected travel route. For example, when the granularity is adjusted from a state wide view to a street level view, the corresponding panoramic view may be adjusted to also reflect the selected degree of granularity. This may include the addition and/or exclusion of various scenic elements and/or contextual parameters from the panoramic view accordingly. It is noted, in certain instances, that the expanded rendering of the panoramic view may correspond to that produced by a fisheye lens or any other panoramic or ultra wide view.

By way of example, the panoramic view generator 111 enables one or more of the following: (1) determining context information to associate with a UE 101 or user based on a routing request submitted to a service 103 and/or via an application 107; (2) processing and/or facilitating a processing of the context information, one or more routes associated with the routing request, or a combination thereof to determine images for depicting one or more scenic elements and/or one or more contextual conditions associated with the one or more routes; (3) cause generation of one or more panoramic views to associate with the one or more routes based on the various determined scenic elements; and (4) causing a presentation of the one or more routes, the one or more panoramic views, or a combination thereof to a display of the device. Per task (3), the generator 111 causes an arranging, sequencing, blending, or a combination thereof of the various images of the scenic elements and/or contextual conditions to produce the various tiles that comprise a panoramic view.

By way of the panoramic view generator 111 operating in connection with a UE 101, users are able to readily ascertain additional details and perceptions of a given travel route beyond that offered by typical routing applications. For example, by virtue of a generated panoramic view, the user may visually access the composition, style, terrain, landscape, environmental factors/patterns and other details of the proposed travel route. In certain embodiments, the generator 111 may also produce textual instructions, icons and other data items for inclusion within the panoramic view. Under this scenario, for example, an icon for representing a location for redemption of a coupon, a graphic of a particular point-of-interest, a description of an event, or other useful information may be presented in connection with a travel route.

As shown in FIG. 1, the system 100 comprises user equipment (UE) 101 having connectivity to the panoramic view generator 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, panoramic view generator 111, applications 107 and various services 103a-103n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

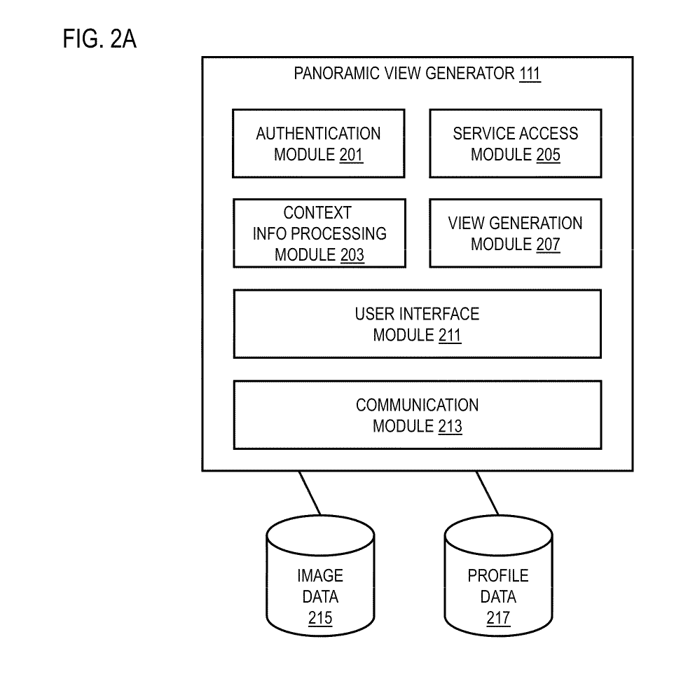

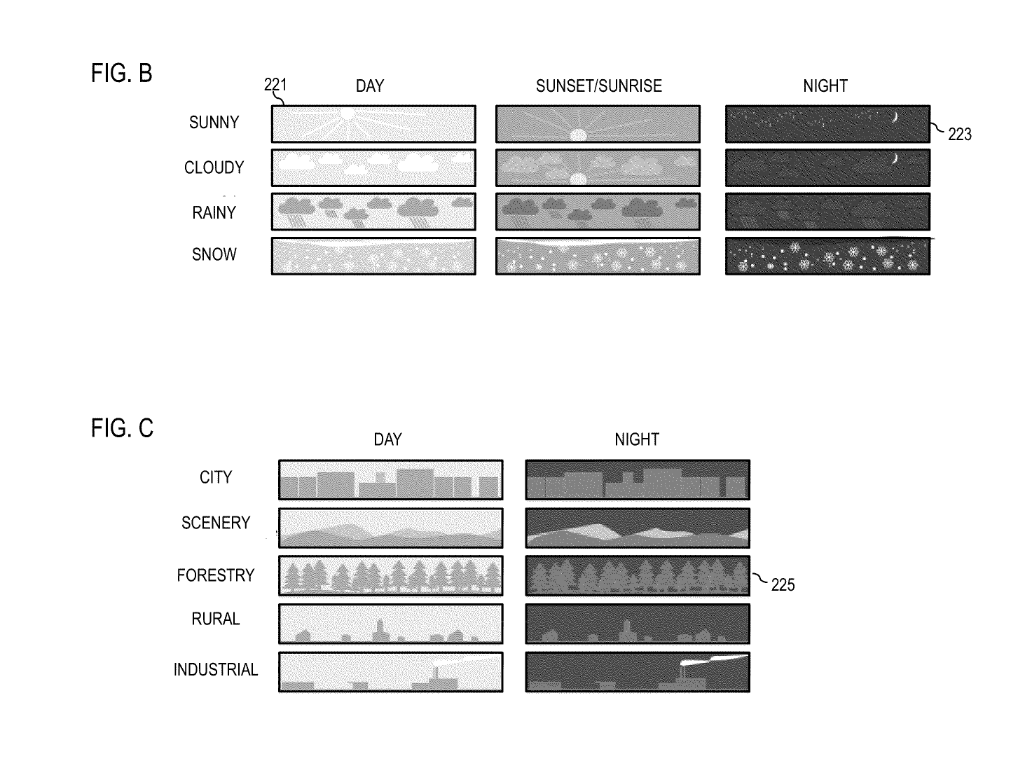

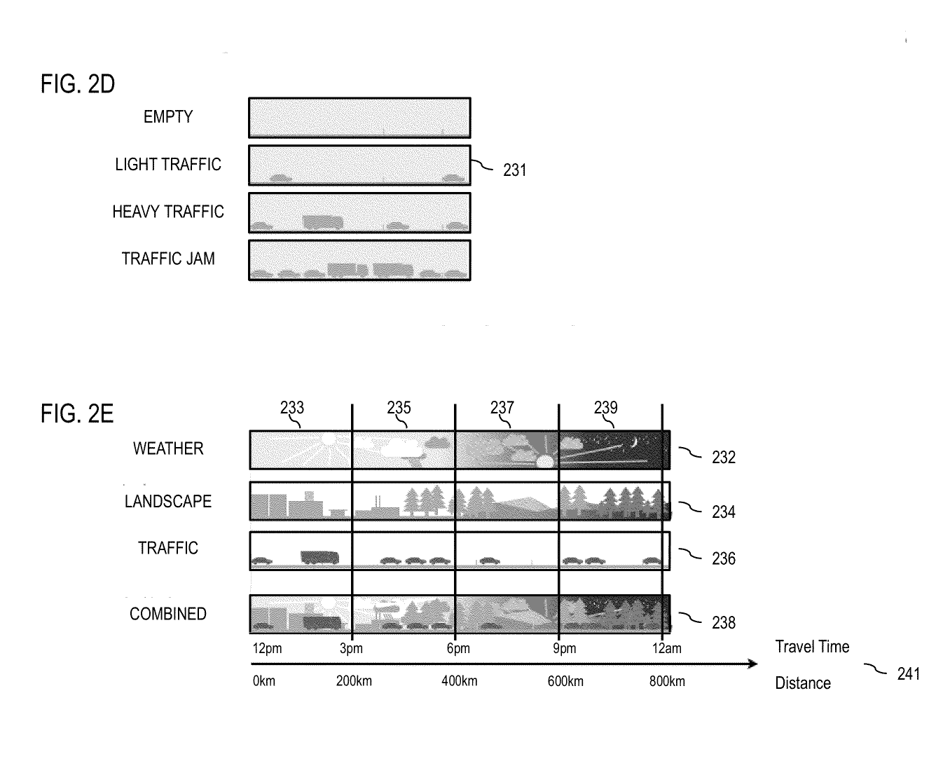

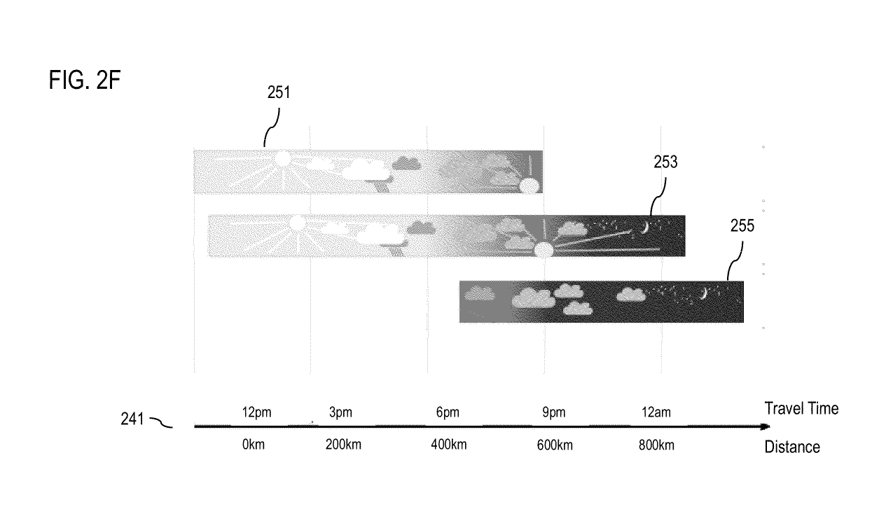

FIG. 2A is a diagram of the components of a panorama image generator, according to one embodiment. By way of example, the panoramic view generator 111 includes one or more components for generating a panoramic image for depicting a selected travel route, according to one embodiment. It is contemplated that the functions of these components may be combined in one or more components or performed by other components of equivalent functionality. In this embodiment, the panoramic view generator 111 includes an authentication module 201, context information processing module 203, service access module 205, view generation module 207, user interface module 211 and communication module 213.

The aforementioned modules 201-213 of the panoramic view generator 111 may also access one or more databases 215 and 217 or performing various executions. This includes, for example, an image database 215 for accessing various images for depicting different scenic elements—i.e., landscapes and styles thereof, points-of-interest (POI) such as buildings and landmarks, icons representative of various conditions, etc. Also included is a profile database 217 for maintaining profile information related to one or more users subscribed to and/or associated with the panoramic view generator 111.

In one embodiment, an authentication module 201 authenticates users and UE 101a-101n for interaction with the panoramic view generator 111. By way of example, the authentication module 201 receives a request to subscribe to the panoramic view generator 111 for enabling generation of panoramic views in connection with a request (e.g., routing request, ticket purchase request). The subscription process may include, for example, establishing one or more services the user is affiliated with as well as their respective access credential information. Subscription may also entail selection of an “opt-in” option, wherein users of the panoramic view generator 111 permit sharing of their context information (e.g., location information, position information and temporal information). Preferences and settings information may be referenced to a specific user, user device, or combination thereof, and maintained as profile data 117. It is further noted, in certain embodiments, that the subscription process may be coordinated with a subscription process of a given service 103 accessed by a user. For example, various input data required for a user to subscribe to a trip planning service or other service 103 may be used for establishing profile data 117 for the panoramic view generator 111.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the panoramic view generator 111 (e.g., as enabled by user interface module 211). Profile data pursuant to registration may be cross referenced as part of the login process. Alternatively, the login process may be performed through automated association of profile settings maintained as profile data 217 with an IP address, a carrier detection signal of a user device, mobile directory number (MDN), subscriber identity module (SIM) (e.g., of a SIM card), radio frequency identifier (RFID) tag or other identifier.

The authentication module 201 may also be alerted of a request initiated via an application 107 or corresponding service 103 by the user. For example, the request may be a request for routing information via a routing service. This request is facilitated via a service access module 205, which enables integration of the generator 111 for use with respect to the various services to which the user is subscribed. It is noted that the service access module 205 enables use of the platform in connection with a service or application as a widget, as a callable executable, as an applet or the like. The authentication module 201 is therefore configured to receive requests for generation of a panoramic view via the service or application.

In one embodiment, the context information processing module 203 receives context information as gathered by the sensors 109a-109n of respective UE 101a-101n. Once received, the context information processing module 207 analyzes the context information 113 to determine the relative location, time, position, weather, traffic and other information useful for generating a panoramic view in association with a given routing request. By way of example, a series of sample points may be computed per the determined request details and gathered context information via the scenic element selection module 209. FIGS. 2B-2F are depictions of images used or generated by the panoramic image generator for representing a selected travel route, according to various embodiments.

In one embodiment, the view generation module 209 facilitates the gathering of the various images corresponding to the determined sample points per the request—i.e., way marks, POI, contextual condition, etc. In addition, the view generation module 209 also generates and compiles the various images into a tileable panoramic view corresponding to the one or more selected images. By way of example, the view generation module 207 may facilitate various image rendering, blending, merging and other compilation techniques for producing a panoramic view.

The view generation module 209 may query one or more location databases and services to obtain representative images corresponding to street data or traffic data for use in generating the panoramic view. Consequently, the image selection may correspond to the determined traffic conditions at a certain point along the route. By way of example, in the case where an area of light traffic is determined at a point along the route, image 231 (FIG. 2D) is selected for use in compilation of the panoramic view. Weather forecast information, geographic and/or topographical data and other information may also be used by the module 207 to permit the accessing of various images for portraying environmental conditions. For example, in the case of a portion of the panoramic view corresponding to a sunny weather condition during the daytime, image 221 of FIG. 2B may be selected while a later time and hence portion/distance along the panoramic view for the same route may correspond to image 223.

Still further, the module 207 may further select various cityscapes or landscapes corresponding to the different time of day for use in generating the panoramic view. By way of example, an area of dense forestry to be traversed by the user during the evening may correspond to image 225, which depicts an evening time forest scenery. These images are tileable, meaning the left and right edges match, such that the view generation module 207 can repeat them to rectangles of arbitrary length, as shown in FIG. 2E. For instance, in the case of a panoramic view 232 depicting the determined weather conditions, multiple tiles 233-239 may be compiled (e.g., tiled and blended) for representing a span of time across the day. The span of time corresponds to the duration of time and/or distance of travel required for completion of the travel route from start to finish. Other panoramic views 234 and 236 depicting the landscape and traffic conditions respectively for the duration of the travel route may also be generated accordingly.

It is noted, per FIG. 2E, that panoramic view 232 corresponds to different time periods as indicated via a travel time and distance indicator 241 (e.g., a horizontal axis). For instance, a time period from 12 am (the starting time) to 3 pm for covering a first 200 km distance of the selected travel route corresponds to tile 233 of the panoramic view 232. Tile 235 corresponds to the period from 3 pm to 6 pm for the second 200 km of the view 232. Tile 237 corresponds to the time period from 6 pm to 9 pm for the third 200 km distance while tile 239 corresponds to the time period from 9 pm to 12 am for the final 200 km distance. While shown as equal increments of time and/or distance in the figure, it is noted that the length and/or segmentation of the tiles may vary depending on the determined distance to be travelled, the amount of time required for travel, various road conditions, etc.

The view generation module 207 also facilitates generation of various views for comparison purposes. Under this scenario, the user may be presented with routing options that vary according to the duration of time associated with the route and/or the length of the panoramic view. By way of example, in FIG. 2F, weather tiles 251-255 may be presented for depicting, in connection with the time and distance indicator 241, various route selections. The different durations (shortest/longest) of routes 251-255 are placed at different start/stop points along the indicator accordingly, such as to enable the user to review and subsequently select a route on the basis of various different contextual and/or logistic factors. Hence, the user may select panoramic view 253 for indicating a preference for the longest scenery, a shorter duration as represented by panoramic view 251 or the quickest route as represented by panoramic view 255. Of note, while panoramic view 255 represents the shortest route, it also indicates night travel is required.

In certain embodiments, the above described panoramic views are generated by the module 207 based on the selected image data 217 and the determined sample points. For example, the view generation module 207 is able to iterate over the sample points for generating matching sections of the prepared images to fill up a render target—i.e., a panoramic view. The module 207 then applies various advanced computer image algorithms for blending, layering, and/or merging the various multiple panoramic views 232-236 for generation of a combined render target 238. The combined render target represents the final panoramic view 238 for depicting the selected travel route.

It is noted that the various images selected for use in generation of a panoramic view may also be composed of aerial imagery and elevation data. Still further, the various images may enable the simulation of the rising/sinking sun to match current drive direction and thus simulate blending of the driver as they traverse a route. Such features may enable generation of varying textures in association with a given panoramic view for enhancing the virtual perspective. Also, the view generation module 207 may enable placement and embedding of text, icons and other elements for representing certain details into a panoramic view. For example, an avatar may be placed at a certain point along a route to indicate the location of a friend affiliated with the user via a social networking service.

Still further, it is contemplated in future embodiments that various three-dimensional images for generation of a forward facing view may be accessed and compiled accordingly by the view generation module 207. Under this scenario, the three dimensional view may be associated with a selected driver's perspective or pedestrian street view perspective, and may also be associated with a virtual reality view (e.g., augmented reality).

In one embodiment the user interface module 211 enables presentment of a graphical user interface for presenting panoramic views in connection with routing information. By way of example, the user interface module 211 generates the interface in response to application programming interfaces (APIs) or other function calls corresponding to the application 107 of UE 101a-101n; thus enabling the display of graphics primitives such as menus, buttons, data entry fields, etc. The user interface module 211 may facilitate the various presentment executions per the service access module 205, thus facilitating the cooperative display of information to the UE 101 per the requirements of the different services capable of being accessed. Still further, the user interface module 211 may be configured to operate in connection with augmented reality (AR) processing techniques, wherein various different applications, graphic elements and features may interact within the same view at the UE 101.

In one embodiment, a communication module 213 enables formation of a session over a network 105 between the panoramic view generator 111 and the services 103. By way of example, the communication module 213 executes various protocols and data sharing techniques for enabling collaborative execution between a subscriber's UE 101a-101n (e.g., mobile devices, laptops, smartphones, tablet computers, desktop computers) and the panoramic view generator 111 over the network 105. It is noted that the communication module 205 is also configured to support a browser session—i.e., the retrieval of content as referenced by a resource identifier during a specific period of time or usage of the browser. The browser session may support execution of a configuration interface for enabling a user to specify various settings for interacting with the generator 111.

The above presented modules and components of the panoramic view generator 111 can be implemented in hardware, firmware, software, or a combination thereof. Though depicted as a separate entity in FIG. 1, it is contemplated that the panoramic view generator 111 may be implemented for direct operation by respective UEs 101a-101n. As such, the panoramic view generator 111 may generate direct signal inputs by way of the operating system of the UE 101 for interacting with the application 107. In another embodiment, one or more of the modules 201-213 may be implemented for operation by respective UEs, as a panoramic view generator 111, or combination thereof. Still further, the panoramic view generator 111 may be integrated for direct operation with a service 103, such as in the form of a widget or applet, in accordance with an information and/or subscriber sharing arrangement. The various executions presented herein contemplate any and all arrangements and models.

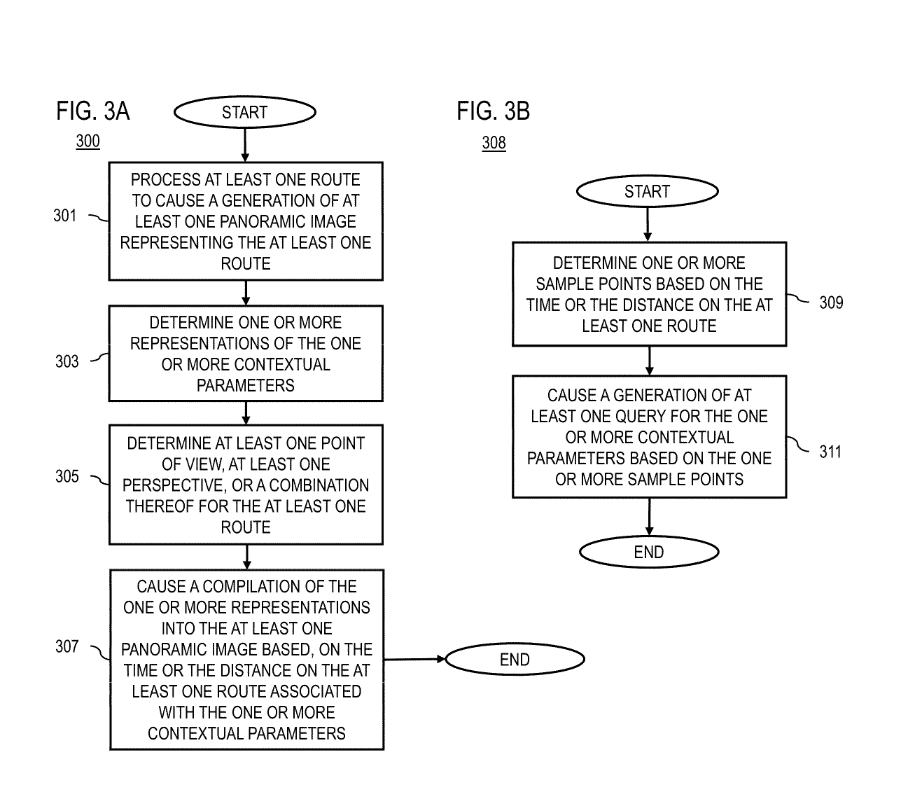

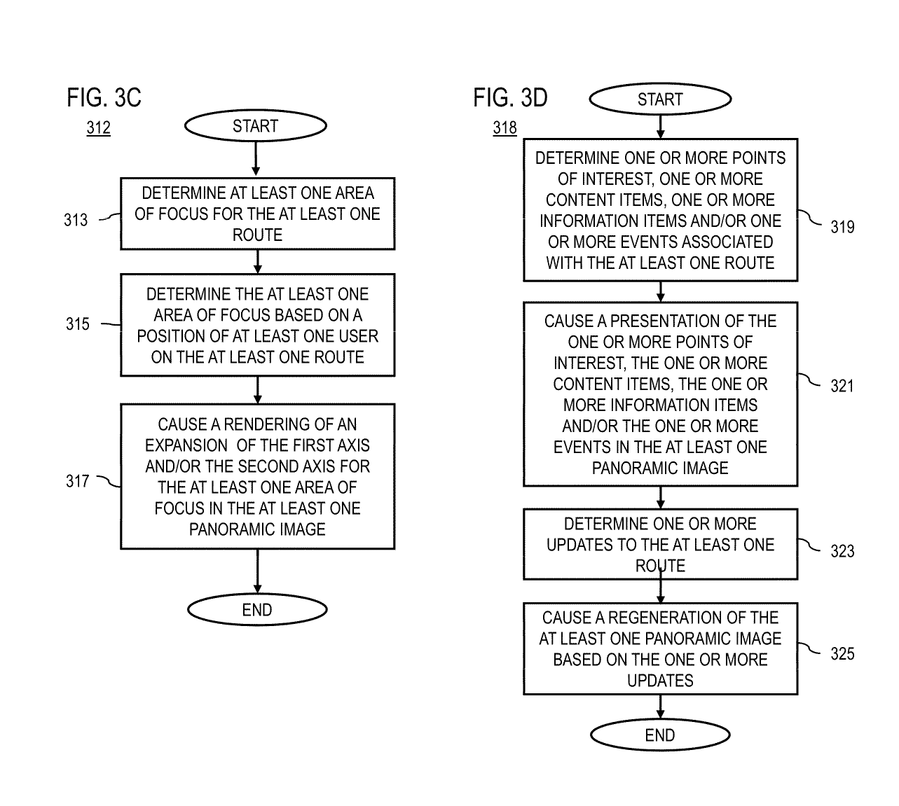

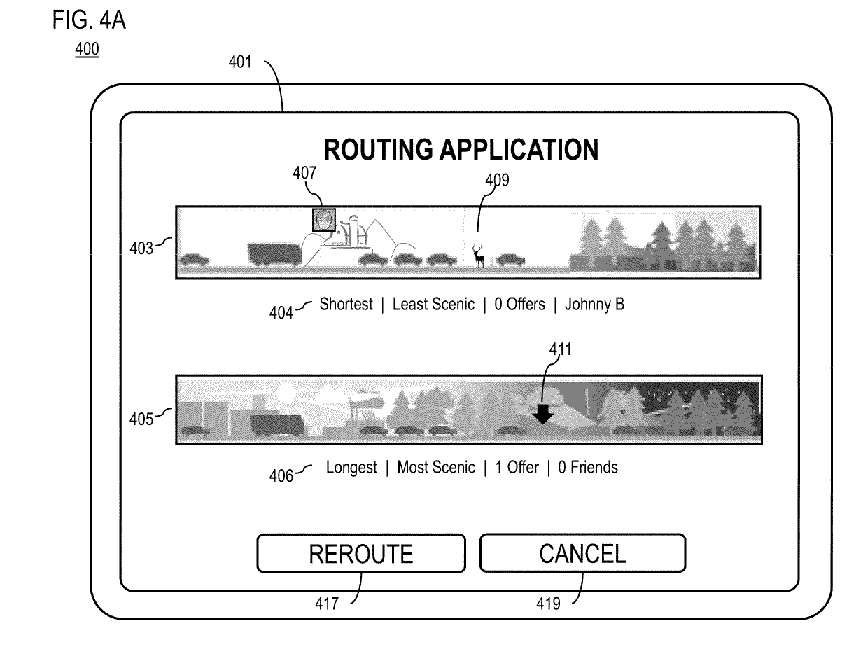

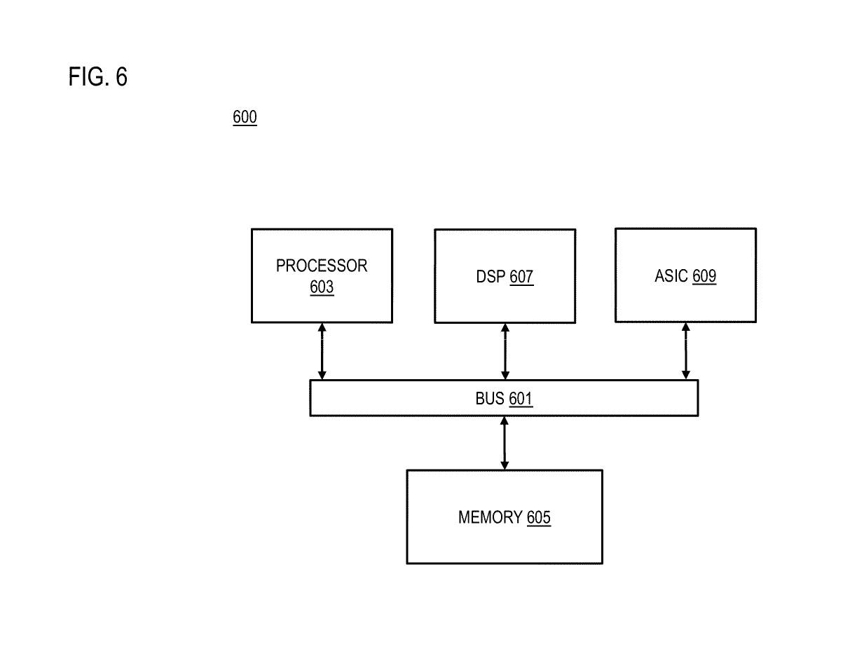

FIGS. 3A-3D are flowcharts of a process for generating a panoramic image for depicting a selected travel route, according to various embodiments. In one embodiment, the panoramic view generator 111 performs processes 300, 308, 312 and 318 and is implemented in, for instance, a chip set including a processor and a memory as shown in FIG. 6.

In step 301 of process 300 (FIG. 3A), the panoramic view generator 111 processes at least one route to cause a generation of at least one panoramic image representing the at least one route. In another step 303, the panoramic view generator 111 determines one or more representations of the one or more contextual parameters. A first axis of the at least one panoramic image represents a time or a distance on the at least one route while a second axis represents the one or more contextual parameters associated with the at least one route. As noted previously, the one or more contextual parameters may be determined based on the analysis of collected contextual data as gathered via various sensors 109 of UE 101.

In step 305, the generator 111 determines at least one point of view, at least one perspective, or a combination thereof for the at least one route. As noted previously, the point of view may correspond to a left or right side of a street or the like. Per step 307, the panoramic view generator causes a compilation of the one or more representations into the at least one panoramic image based, on the time or the distance on the at least one route associated with the one or more contextual parameters.

In step 309 of process 308 (FIG. 3B), the panoramic view generator 111 determines one or more sample points based on the time or the distance on the at least one route. Per step 311, the generator 111 also causes a generation of at least one query for the one or more contextual parameters based on the one or more sample points. In certain instances, the sample points may correspond to a particular time/distance for representing of a given scenic element pursuant to a routing request.

In step 313 of process 312 (FIG. 3C), the panoramic view generator 111 determines at least one area of focus for the at least one route. In step 315, the generator 111 also determines the at least one area of focus based on a position of at least one user on the at least one route. Per step 317, the generator 111 further causes a rendering of an expansion of the first axis and/or the second axis for the at least one area of focus in the at least one panoramic image. The expansion may correspond to one or more wide image rendering techniques.

In step 319 of process 318 (FIG. 3D), the panoramic view generator 111 determines one or more points of interest, one or more content items, one or more information items and/or one or more events associated with the at least one route. In step 321, the generator 111 causes a presentation of the one or more points of interest, the one or more content items, the one or more information items and/or the one or more events in the at least one panoramic image.

Per steps 323 and 325 respectively, the panoramic view generator 111 determines one or more updates to the at least one route and causes a regeneration of the at least one panoramic image based on the one or more updates. Hence, a panoramic view may be persistently updated to account for changes in contextual conditions, user behavior and activity, etc.

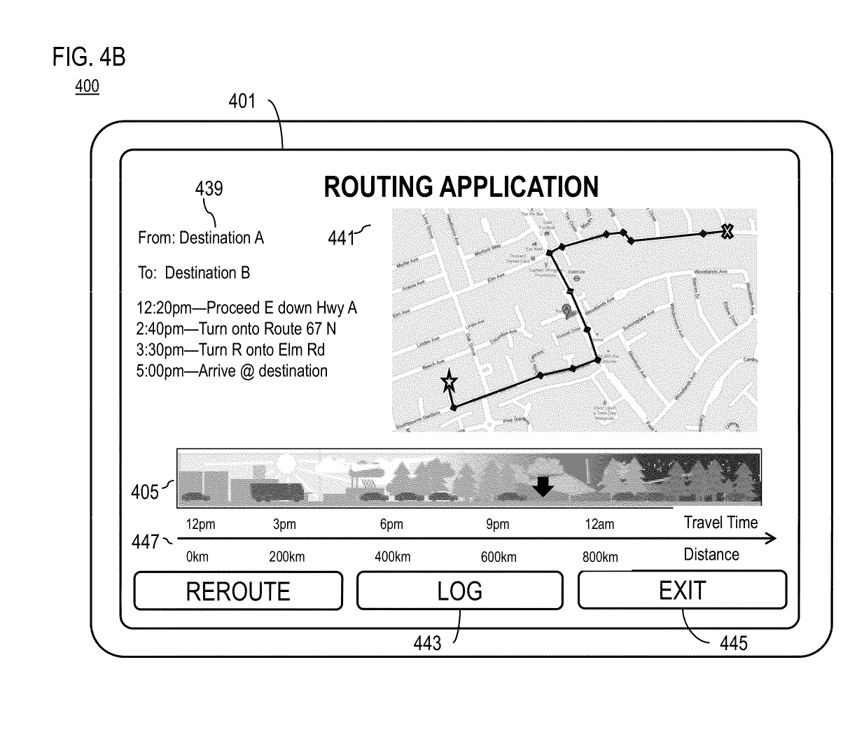

FIGS. 4A and 4B are diagrams of user interfaces utilized in the processes of FIGS. 3A-3D, according to various embodiments. For the purpose of illustration, the diagrams are described with respect to an exemplary use case of a user interacting with the panoramic view generator 111 via a mobile device. In this example, the user is presented with various panoramic views in response to the entry of routing criteria and an associated routing request via a routing application and/or service.

In FIG. 4A, the user is presented (to display 401) with different panoramic views 403 and 405 for depicting different travel routes. As noted previously, the panoramic views are comprise various merged, blended and otherwise rendered tiles for depicting a final representation of the travel route from start-to-finish. In this example, the panoramic views begin from the leftmost tile edge to the rightmost tile edge corresponding to a left side perspective. Panoramic view 403 is presented along with a caption 404 for briefly describing the route. In this case, the caption indicates that the view 403 corresponds to the shortest route, is the least scenic, has zero offers and/or incentives associated with the route, and features is associated with the location of a friend named Johnny B. Panoramic view 405 also includes a caption 406 for defining the route. The caption 406 indicates that the panoramic view 405 corresponds to the longest route, is the most scenic, includes one point-of-interest corresponding to a location for redemption of an offer, and is not associated with any locations of known friends of the user.

Per this example, in the case of a friend being associated with a particular location along the route, an avatar 407 corresponding to the friend or other icon is presented within the panoramic view 403 at that location. Also, icon 409 is presented for indicating the known presence of deer and other animals at the point along the point along the route. Additional other images for depicting conditions the user may experience may also be embedded within the view 403, including images representing road hazards, blockades, construction work, etc. Icon 411 is also presented with respect to the location of a place where a particular coupon or offer may be redeemed. Under this scenario, the panoramic view generator 111 may operate in connection with a coupon and/or incentive generation/finding service for integrated use with the routing application.

The user can review the various panoramic views 403 and 405 then select a REROUTE action button 417 to select a different routing option or the CANCEL action button 419 to exit from the panoramic view selection screen. For the

[symbol]

In FIG. 4B, the user is presented with a combined view of the routing information (e.g., as generated by the routing application) in conjunction with a selected panoramic view. For the purpose of illustration, is it assumed the user selected panoramic view 405 per the interface view of FIG. 4A as their route of choice. As a result, the user is presented with the text based routing instructions via section 439 of the user interface 401. In addition, the user is presented with mapping information corresponding to the route via section 441 of the user interface 401. It is noted that the panoramic view 405 may be adapted to account for changes in the user behavior (e.g., straying from the travel route, intermittent starting and stopping) or contextual conditions associated with the route (e.g., traffic accident or weather changes). Also, the panoramic view 405 may be adapted relative to the distance traversed by the user along the route. For example, in the case where the user has travelled 107 kilometers of the trip, the portion of the panoramic view 405 corresponding to this distance along the travel time and distance indicator (e.g., a horizontal axis) may be removed. Hence, the updated panoramic view may feature only those sections that are relevant to the users remaining travel and line of sight.

As a tileable images are used to generate the panoramic view 405, it is contemplated that the panoramic view may be rendered to the display in a scrolling fashion. As such, certain sections of the panoramic view 405 may scroll off or onto the screen (via the render target) as the user actively traverses the travel route. It is further contemplated that the user may toggle the granularity of the view to adapt the panoramic viewing experience. For example, when a granularity indicator 451 is selected to increase the granularity of the map 441, the corresponding panoramic view 405 may also be adapted.

The user may exit the routing application by selecting the EXIT action button 445. Also, the user may select a LOG action button 443, for enabling advanced data logging and/or sharing functions. For example, the user may log the routing information and corresponding panoramic view 405 to a travel log associated with their user profile or upload the data to a their social networking service. Under this scenario, the user is able to keep a visual record of their various travels as well as share the information with friends. Alternatively, the user may append messages, pictures, videos or other data to the panoramic view 405 for generation of an interactive journey scrapbook. In certain embodiments, the various panoramic views stored and shared by different users may be used by the routing application for responding to future routing requests (e.g., present the most popular or highest recommended panoramic views for a given route to be travelled).

The processes described herein for generating a panoramic image for depicting a selected travel route may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

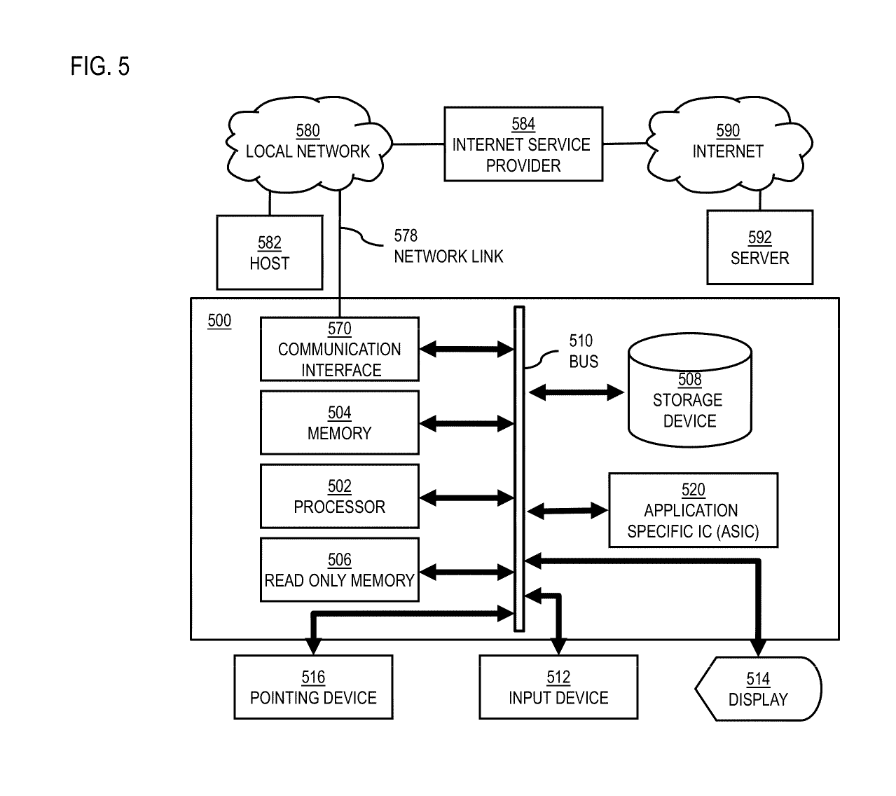

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to generate a panoramic image for depicting a selected travel route as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of generating a panoramic image for depicting a selected travel route.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to generate a panoramic image for depicting a selected travel route. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for generating a panoramic image for depicting a selected travel route. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for generating a panoramic image for depicting a selected travel route, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for generating a panoramic image for depicting a selected travel route to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to generate a panoramic image for depicting a selected travel route as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of generating a panoramic image for depicting a selected travel route.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to generate a panoramic image for depicting a selected travel route. The memory 605 also stores the data associated with or generated by the execution of the inventive steps.

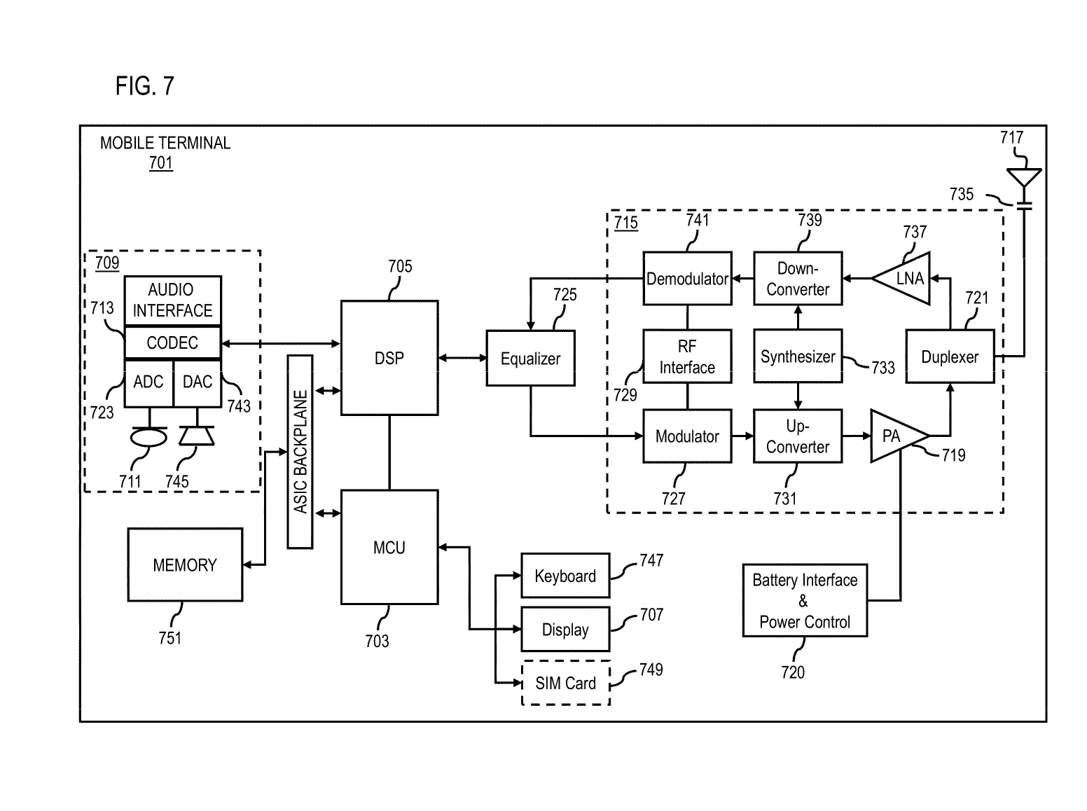

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of generating a panoramic image for depicting a selected travel route. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of generating a panoramic image for depicting a selected travel route. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to generate a panoramic image for depicting a selected travel route. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of at least one route to cause, at least in part, a generation of at least one panoramic image representing the at least one route,
wherein a first axis of the at least one panoramic image represents a time or a distance on the at least one route, and
wherein a second axis represents one or more contextual parameters associated with the at least one route.

2. A method of claim 1, wherein the (1) data and/or (2) information and/or (3) at least one signal are further based, at least in part, on the following:
one or more representations of the one or more contextual parameters; and
a compilation of the one or more representations into the at least one panoramic image based, at least in part, on the time or the distance on the at least one route associated with the one or more contextual parameters.

3. A method of claim 2, wherein the one or more representations further depict, at least in part, one or more landscapes, one or more styles of the one or more landscapes, one or more cityscapes, one or more other styles of the one or more cityscapes, or a combination thereof

4. A method of claim 3, wherein the one or more representations include, at least in part, one or more image tiles representing at least in part, the one or more contextual parameters, the one or more landscapes, the one or more styles of the one or more landscapes, the one or more cityscapes, the one or more other styles of the one or more cityscapes, or a combination thereof.

5. A method of claim 2, wherein the (1) data and/or (2) information and/or (3) at least one signal are further based, at least in part, on the following:
at least one determination of at least one point of view, at least one perspective, or a combination thereof for the at least one route,
wherein the generation of the at least one panoramic image is based, at least in part, on the at least one point of view, the at least one perspective, or a combination thereof.

6. A method of claim 1, wherein the (1) data and/or (2) information and/or (3) at least one signal are further based, at least in part, on the following:
at least one determination of one or more sample points based, at least in part, on the time or the distance on the at least one route; and
a generation of at least one query for the one or more contextual parameters based, at least in part, on the one or more sample points.

7. A method of claim 1, wherein the (1) data and/or (2) information and/or (3) at least one signal are further based, at least in part, on the following:
at least one area of focus for the at least one route; and
a rendering of an expansion of the first axis, the second axis, or a combination thereof for the at least one area of focus in the at least one panoramic image.

8. A method of claim 7, wherein the (1) data and/or (2) information and/or (3) at least one signal are further based, at least in part, on the following:
at least one determination of at least one area of focus based, at least in part, on a position of at least one user on the at least one route.

9. A method of claim 1, wherein the (1) data and/or (2) information and/or (3) at least one signal are further based, at least in part, on the following:
at least one determination of one or more points of interest, one or more content items, one or more information items, one or more events, or a combination thereof associated with the at least one route; and
a presentation of the one or more points of interest, the one or more content items, the one or more information items, the one or more events, or a combination thereof in the at least one panoramic image.

10. A method of claim 1, wherein the (1) data and/or (2) information and/or (3) at least one signal are further based, at least in part, on the following:
one or more updates to the at least one route; and
a regeneration of the at least one panoramic image based, at least in part, on the one or more updates.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of at least one route to cause, at least in part, a generation of at least one panoramic image representing the at least one route,
wherein a first axis of the at least one panoramic image represents a time or a distance on the at least one route, and
wherein a second axis represents one or more contextual parameters associated with the at least one route.

12. An apparatus of claim 11, wherein the apparatus is further caused to:
determine one or more representations of the one or more contextual parameters; and
cause, at least in part, a compilation of the one or more representations into the at least one panoramic image based, at least in part, on the time or the distance on the at least one route associated with the one or more contextual parameters.

13. An apparatus of claim 12, wherein the one or more representations further depict, at least in part, one or more landscapes, one or more styles of the one or more landscapes, one or more cityscapes, one or more other styles of the one or more cityscapes, or a combination thereof.

14. An apparatus of claim 13, wherein the one or more representations include, at least in part, one or more image tiles representing at least in part, the one or more contextual parameters, the one or more landscapes, the one or more styles of the one or more landscapes, the one or more cityscapes, the one or more other styles of the one or more cityscapes, or a combination thereof

15. An apparatus of claim 12, wherein the apparatus is further caused to:
determine at least one point of view, at least one perspective, or a combination thereof for the at least one route,
wherein the generation of the at least one panoramic image is based, at least in part, on the at least one point of view, the at least one perspective, or a combination thereof

16. An apparatus of claim 11, wherein the apparatus is further caused to:
determine one or more sample points based, at least in part, on the time or the distance on the at least one route; and
causing, at least in part, a generation of at least one query for the one or more contextual parameters based, at least in part, on the one or more sample points.

17. An apparatus of claim 11, wherein the apparatus is further caused to:
determine at least one area of focus for the at least one route; and
cause, at least in part, a rendering of an expansion of the first axis, the second axis, or a combination thereof for the at least one area of focus in the at least one panoramic image.

18. An apparatus of claim 17, wherein the apparatus is further caused to:
determine the at least one area of focus based, at least in part, on a position of at least one user on the at least one route

19. An apparatus of claim 11, wherein the apparatus is further caused to:
determine one or more points of interest, one or more content items, one or more information items, one or more events, or a combination thereof associated with the at least one route; and
cause, at least in part, a presentation of the one or more points of interest, the one or more content items, the one or more information items, the one or more events, or a combination thereof in the at least one panoramic image.

20. An apparatus of claim 11, wherein the apparatus is further caused to:
determine one or more updates to the at least one route; and
cause, at least in part, a regeneration of the at least one panoramic image based, at least in part, on the one or more updates.

21-48. (canceled)
